(19) United States
(12) Patent Application Publication
(10) Pub. No.: US 2014/0354689 A1
(43) Pub. Date: Dec. 4, 2014

(54) DISPLAY APPARATUSES AND CONTROL METHODS THEREOF

(71) Applicant: Samsung Electronics Co., Ltd., Suwon-Si (KR)

(72) Inventors: Hee Kuk LEE, Suwon-si (KR); No San KWAK, Suwon-si (KR); Won Jun HWANG, Seoul (KR)

(73) Assignee: SAMSUNG ELECTRONICS CO., LTD., Suwon-Si (KR)

(21) Appl. No.: 14/078,989

(22) Filed: Nov. 13, 2013

(30) Foreign Application Priority Data
May 28, 2013 (KR) 10-2013-0060461

(51) Int. Cl. G06T 19/00

(52) U.S. Cl. CPC G06T 19/006
USPC 345/633; 345/156

(57) ABSTRACT

A display apparatus may include a display unit configured to display images; a first camera, mounted on a surface of the display unit on which the images are displayed, configured to acquire an image of a user's face; a second camera, mounted on a surface of the display unit opposite to the first camera, configured to acquire an image of an object; and/or a controller configured to detect a gaze direction of the user from the image of the user's face acquired by the first camera, configured to control a shooting direction of the second camera to match the detected gaze direction, and configured to display the image of the object acquired by the second camera, having an adjusted shooting direction, on the display unit.

### CROSS-REFERENCE TO RELATED APPLICATION(S)

This application claims priority from Korean Patent Application No. 2013-0060461, filed on May 28, 2013, in the Korean Intellectual Property Office (KIPO), the entire contents of which are incorporated herein by reference.

### BACKGROUND

1. Field

Some example embodiments may relate to display apparatuses that display images of objects and/or methods of controlling the same.

2. Description of Related Art

Minimally invasive surgery generally refers to surgery capable of minimizing incision size and recovery time. Differently from laparotomy using relatively large surgical incisions through a part of a human body (e.g., the abdomen), in minimally invasive surgery, after forming at least one small incision (or invasive hole) of 0.5 cm to 1.5 cm through the abdominal wall, an operator inserts an endoscope and surgical tools through the incision, to perform surgery while viewing images provided via the endoscope.

Upon comparison with laparotomy, such minimally invasive surgery causes less post-operative pain, faster recovery of bowel movement, earlier restoration of ability to eat, shorter hospitalization, faster return to daily life, and better cosmetic effects owing to small incision size. Due to these properties, minimally invasive surgery is used for cholecystectomy, prostatic carcinoma surgery, hernia repair, and the like, and applications thereof continue to grow.

In general, a surgical robot used in minimally invasive surgery includes a master device and a slave device. The master device generates a control signal in accordance with manipulation of a doctor and transmits the control signal to the slave device. The slave device receives the control signal from the master device and performs manipulation required for surgery upon a patient. The master device and the slave device may be integrated, or may be separately arranged in an operating room.

The slave device includes at least one robot arm. A surgical instrument is mounted on an end of each robot arm, and in turn a surgical tool is mounted on an end of the surgical instrument.

In minimally invasive surgery using the aforementioned surgical robot, the surgical tool of the slave device and the surgical instrument provided with the surgical tool, are introduced into a patient's body to perform required procedures. In this case, after the surgical tool and the surgical instrument enter the human body, an internal status is visible from images acquired by an endoscope, which is one type of the surgical instrument, and medical images of the patient, such as a computed tomography (CT) image and a magnetic resonance imaging (MRI) image, acquired before surgery are used as references.

### SUMMARY

Some example embodiments may provide display apparatuses capable of instinctively observing the inside of a patient's body.

In some example embodiments, a display apparatus may comprise: a display unit configured to display images; a first camera, mounted on a surface of the display unit on which the images are displayed, configured to acquire an image of a user's face; a second camera, mounted on a surface of the display unit opposite to the first camera, configured to acquire an image of an object; and/or a controller configured to detect a gaze direction of the user from the image of the user's face acquired by the first camera, configured to control a shooting direction of the second camera to match the detected gaze direction, and configured to display the image of the object acquired by the second camera, having an adjusted shooting direction, on the display unit.

In some example embodiments, the display apparatus may further comprise an actuator configured to control the shooting direction of the second camera. The controller may be configured to drive the actuator to allow the shooting direction of the second camera to match the detected gaze direction.

In some example embodiments, the actuator may be installed between the second camera and the display unit. The actuator may be configured to tilt the second camera to control the shooting direction of the second camera.

In some example embodiments, the second camera may comprise a wide angle lens. The controller may be configured to extract an image corresponding to the detected gaze direction from images acquired by the second camera comprising the wide angle lens and/or may be configured to display the extracted image on the display unit.

In some example embodiments, the display apparatus may further comprise a plurality of second cameras mounted on the surface of the display unit opposite to the first camera. The controller may be configured to match images captured by the plurality of second cameras, may be configured to extract an image corresponding to the detected gaze direction from the matched images, and/or may be configured to display the extracted image on the display unit.

In some example embodiments, the second camera may comprise a plurality of image sensors. The controller may be configured to extract an image corresponding to the detected gaze direction from images sensed by the plurality of image sensors, and/or may be configured to display the extracted image on the display unit.

In some example embodiments, the display unit may be a liquid crystal display (LCD) or a semi-transparent LCD.

In some example embodiments, the controller may be configured to detect the gaze direction of the user from the image of the user's face captured by the first camera and is configured to control the shooting direction of the second camera in real time to match the gaze direction detected in real time.

In some example embodiments, the controller may be configured to display an augmented reality image generated using a virtual image of an inside of the object and overlaying the virtual image upon the image captured by the second camera on the display unit.

In some example embodiments, the controller may be configured to generate a virtual image by converting an image of an inside of the object into a three-dimensional image.

In some example embodiments, the image of the inside of the object may comprise at least one image selected from a group consisting of an image captured by a medical imaging apparatus, an image of a surgical region, and a surgical tool captured by an endoscope.

In some example embodiments, the medical imaging apparatus may comprise a computed tomography (CT) apparatus or a magnetic resonance imaging (MRI) apparatus.

In some example embodiments, a surgical robot system may comprise: a slave system configured to perform a surgical operation upon an object; a master system configured to control the surgical operation of the slave system; an imaging system configured to generate a virtual image of an inside of the object; and/or a display apparatus. The display apparatus may comprise: a display unit configured to display images; a first camera, mounted on a surface of the display unit on which the images are displayed, configured to acquire an image of a user's face; a second camera, mounted on a surface of the display unit opposite to the first camera, configured to acquire an image of an object; and/or a controller configured to detect a gaze direction of the user from the image of the user's face acquired by the first camera, configured to control a shooting direction of the second camera to match the detected gaze direction, and configured to display an augmented reality image, generated by overlaying the virtual image upon the image of the object acquired by the second camera, having an adjusted shooting direction, on the display unit.

In some example embodiments, the imaging system may comprise a virtual image generator configured to generate the virtual image by converting the image of the inside of the object into a three-dimensional image; and/or a storage unit configured to store the virtual image.

In some example embodiments, the image of the inside of the object may comprise an image acquired by a medical imaging apparatus, comprising a computed tomography (CT) apparatus or a magnetic resonance imaging (MRI) apparatus, and an image of a surgical region and a surgical tool captured by an endoscope. The virtual image generator may be configured to generate the virtual image by converting the image acquired by the medical imaging apparatus comprising a CT apparatus or a MRI apparatus into a three-dimensional image and projecting the converted three-dimensional image onto the image of the surgical region and the surgical tool captured by the endoscope.

In some example embodiments, a method of controlling a mobile display apparatus may comprise: detecting a gaze direction of a user from an image of the user's face acquired by a first camera of the mobile display apparatus; controlling a shooting direction of a second camera of the mobile display apparatus to match the gaze direction; and/or displaying an image acquired by the second camera, having an adjusted shooting direction, on a display unit of the mobile display apparatus.

In some example embodiments, the method may further comprise generating a virtual image of an inside of an object; and/or displaying an augmented reality image generated by overlaying the virtual image of the object upon an image acquired by the second camera on the display unit.

In some example embodiments, a display apparatus may comprise a display unit configured to display images; a first camera, on a first side of the display unit, configured to acquire an image of a face of a user; a second camera, on a second side of the display unit, configured to acquire an image of an object; and/or a controller configured to detect a gaze direction of the user from the acquired image of the face of the user, and configured to control a shooting direction of the second camera so that the shooting direction matches the detected gaze direction.

In some example embodiments, the display apparatus may further comprise an actuator configured to adjust the shooting direction of the second camera. The controller may drive the actuator.

In some example embodiments, the display apparatus may further comprise an actuator configured to adjust the shooting direction of the second camera. The actuator may be operatively connected between the display unit and the second camera. The controller may drive the actuator.

In some example embodiments, the second camera may comprise a wide angle lens. The controller may be configured to extract an image corresponding to the detected gaze direction from a plurality of images acquired by the second camera.

In some example embodiments, the second camera may comprise a plurality of image sensors. The controller may be configured to extract an image corresponding to the detected gaze direction from images sensed by the plurality of image sensors.

In some example embodiments, the display apparatus may further comprise a plurality of second cameras on the second side of the display unit. The controller may be configured to match images captured by the plurality of second cameras, and/or may be configured to extract an image corresponding to the detected gaze direction from the matched images.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a block diagram illustrating a display apparatus;

FIG. 2 is a side view schematically illustrating the display apparatus;

FIG. 3 is a front view illustrating the display apparatus;

FIG. 4 is a rear view illustrating the display apparatus;

FIG. 5 is a diagram illustrating control of a shooting direction of a second camera of the display apparatus;

FIGS. 6 and 7 respectively illustrate another example of the display apparatus;

FIGS. 8-11 are flowcharts illustrating methods of controlling display apparatuses;

FIG. 12 is a diagram illustrating a surgical robot system;

FIG. 13 is a block diagram schematically illustrating constituent elements of a surgical robot system;

FIGS. 14 and 15 are diagrams illustrating augmented reality images according to gaze directions of a user; and

FIG. 16 is a diagram illustrating an image of a surgical region acquired via an endoscope and an augmented reality image having a real surgical tool and a virtual surgical tool.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

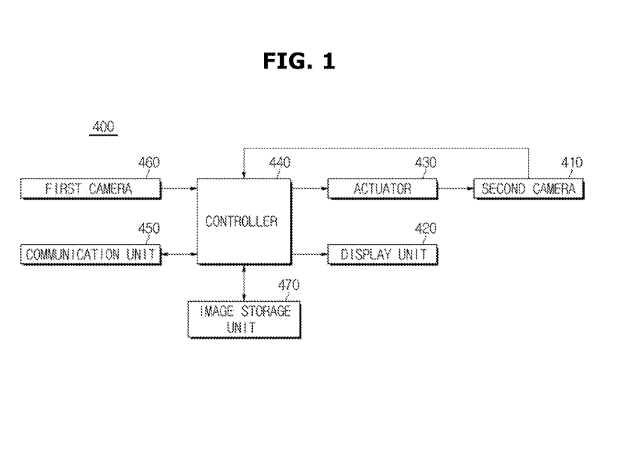

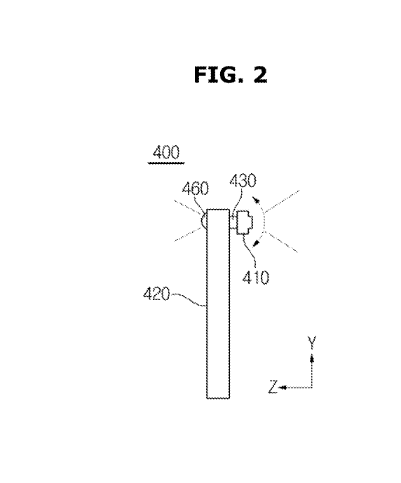

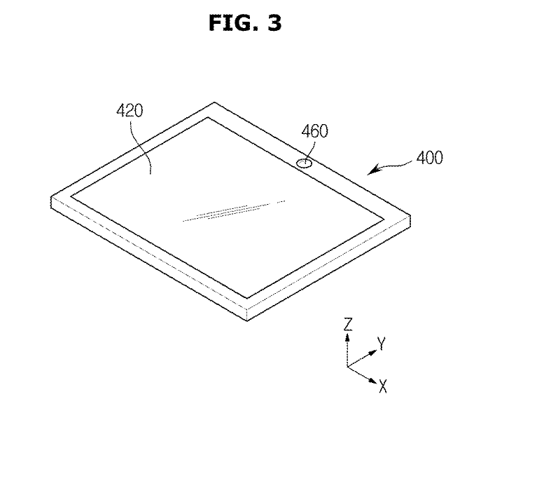

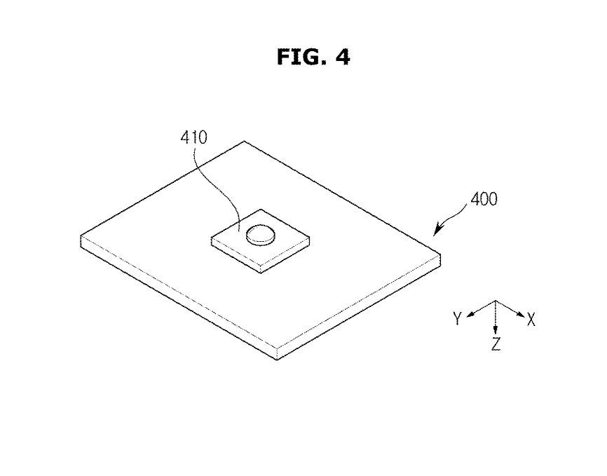

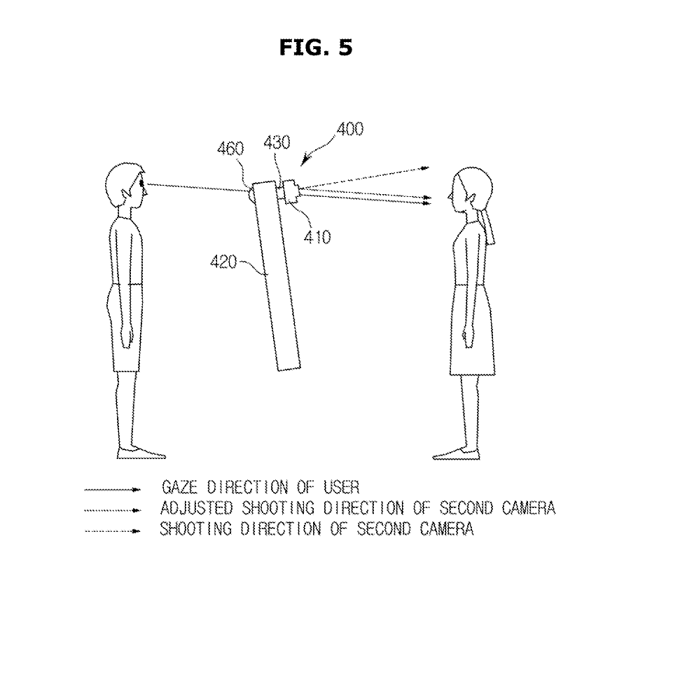

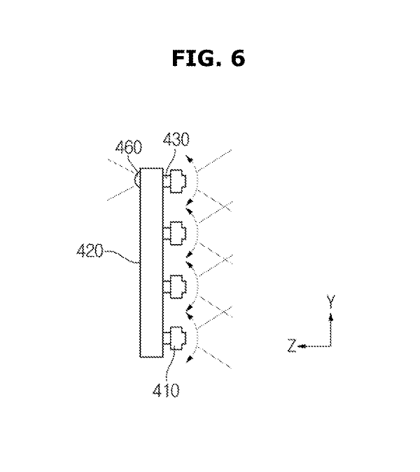

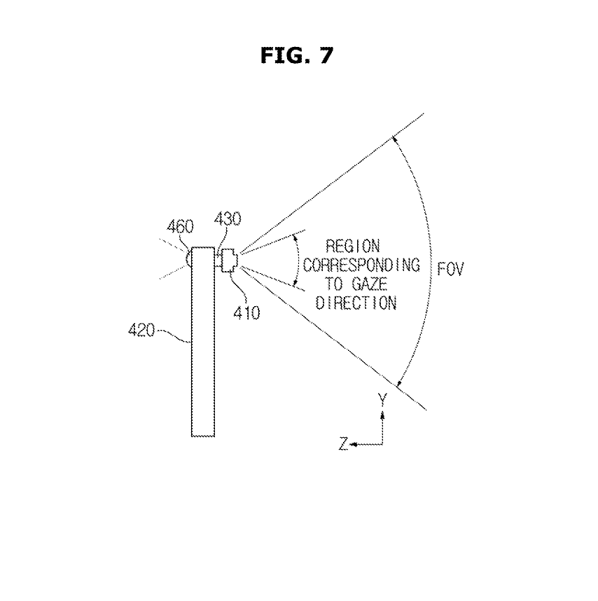

FIG. 1 is a block diagram illustrating a display apparatus 400. FIG. 2 is a side view schematically illustrating the display apparatus 400. FIG. 3 is a front view illustrating the display apparatus 400, and FIG. 4 is a rear view illustrating the display apparatus 400. FIG. 5 is a diagram illustrating control of a shooting direction of a second camera 410 of the display apparatus 400. FIGS. 6 and 7 respectively illustrate another example of the display apparatuses 400.

The display apparatus 400 includes a display unit 420 to display an image, a first camera 460 mounted on the front surface of the display apparatus 400, a second camera 410 mounted on the rear surface of the display apparatus 400, an actuator 430 to control a shooting direction of the second camera 410, a communication unit 450 to perform communications with an external device, and a controller 440 to control overall operation of the display apparatus 400.

The display apparatus 400 may be fixed at a particular position or portable. The display unit 420 may be implemented using various known display techniques and may be a liquid crystal display (LCD) or a semi-transparent LCD.

As illustrated in FIGS. 2 and 3, the first camera 460 is mounted at an upper end of the front surface of display apparatus 400. The first camera 460 may also be mounted at another position of the front surface of the display apparatus 400. However, the first camera 460 may be mounted at the upper end to capture an image of a face, particularly, eyes, of a user of the display apparatus 400.

The first camera 460 outputs data acquired by capturing an image of the face of the user of the display apparatus 400 to the controller 440.

The first camera 460 continuously captures images of the user's face during operation of the display apparatus 400 and outputs data acquired during image capture to the controller 440 in real time.

The second camera 410 is mounted on the rear surface of the display apparatus 400 as illustrated in FIGS. 2 and 4. The position where the second camera 410 is installed is not restricted so long as the second camera 410 is mounted at the rear surface of the display apparatus 400. Hereinafter, the second camera 410 mounted at an upper portion of the rear surface of the display apparatus 400 to correspond to the position of the first camera 460 will be exemplarily described.

The second camera 410 outputs data acquired by capturing an image of a landscape or object located at the rear side of the display apparatus 400 to the controller 440. The second camera 410 continuously captures images of the landscape or object located at the rear side of the display apparatus 400 during operation of the display apparatus 400 and outputs data acquired via the image capturing process to the controller 440 in real time.

The first camera 460 and the second camera 410 may respectively be a complementary metal-oxide semiconductor (CMOS) camera or a charge coupled device (CCD) camera without being limited thereto.

The image captured by the second camera 410 is displayed on the display unit 420 in the same size of the landscape or object as that perceived by eyes of the user, such that the user does not perceive that the image captured by the second camera 410 displayed on the display unit 420 is considerably different from the real view of the landscape or object. Shooting conditions of the second camera 410 may be preset such that the landscape or object located at the rear side thereof is displayed in the same size as that perceived by eyes of the user. In addition, the mage may be processed by the controller 440 such that the image captured by the second camera 410 is displayed on the display unit 420 in real size.

Thus, the image captured by the second camera 410 and displayed on the display unit 420 may be in harmony with the ambient background without causing considerable discontinuity. The user may perceive that the rear side view blocked by the display apparatus 400 is projected onto the display unit 420 while viewing the image captured by the second camera 410 and displayed on the display unit 420.

However, a direction viewed by the user, hereinafter, referred to as gaze direction, changes. In this case, when the image displayed on the display unit 420 is not changed, the user cannot perceive that the landscape or object located at the rear side of the display apparatus 400 is projected onto the display unit 420.

Thus, the display apparatus 400 according to the illustrated embodiment changes the shooting direction of the second camera 410 in accordance with the gaze direction of the user such that the image captured by the second camera 410 and displayed on the display unit 420 is in harmony with the ambient background. Hereinafter, this will be described in more detail.

The second camera 410 is mounted at the display unit 420 via the actuator 430. That is, as illustrated in FIG. 2, the actuator 430 that provides driving force to control the shooting direction of the second camera 410 is disposed between the display unit 420 and the second camera 410.

The actuator 430 tilts the second camera 410 upward, downward, rightward, or leftward, or a direction in which the four directions are combined with respect to a Z-axial direction to control the shooting direction of the second camera 410.

For example, the actuator 430 tilts the second camera 410 in a Y-axis direction such that the second camera 410 faces a lower position compared to that before tilting. Alternatively, the actuator 430 tilts the second camera 410 in an X-axis direction such that the second camera 410 faces a left position compared to that before tilting based on FIG. 3.

The direction in which the second camera 410 is tilted by the actuator 430 and the degree of tilting vary according to drive signals output from the controller 440.

The controller 440 detects the gaze direction of the eyes of the user based on data with regard to an image of the user's face output from the first camera 460.

When the first camera 460 captures an image of the user's face and outputs the image to the controller 440, the controller 440 detects the gaze direction of the user based on movement of pupils of the user's face or detects the gaze direction based on a rotation direction of the user's face. Alternatively, the gaze direction of the user is detected by combining the rotation direction of the user's face and the movement of the pupils of the user.

The display apparatus 400 may pre-store algorithms to detect the gaze direction of the user, and the controller 440 may detect the gaze direction of the user using the algorithms.

When the gaze direction of the user is detected based on the image captured by the first camera 460, the controller 440 controls the shooting direction of the second camera 410 such that the shooting direction of the second camera 410 matches the detected gaze direction.

As illustrated in FIG. 5, under the condition that the second camera 410 faces a lower position than the detected gaze direction of the user, the controller 440 outputs a drive signal to drive the actuator 430 so as to tilt the second camera 410 such that the shooting direction of the second camera 410 is changed upward to match the user gaze direction.

The actuator 430 tilts the second camera 410 in accordance with the drive signal output from the controller 440 such that the shooting direction of the second camera 410 matches to the gaze direction of the user.

The controller 440 detects the gaze direction of the user in real time based on the image captured by the first camera 460. When a change of the gaze direction is detected, the controller 440 drives the actuator 430 in real time such that the shooting direction of the second camera 410 matches the changed gaze direction.

FIGS. 6 and 7 respectively illustrate another example for changing the image captured by the second camera 410 and displayed on the display unit 420 in accordance with the gaze direction of the user.

Referring to FIG. 6, a plurality of second cameras 410 is mounted on the display apparatus 400.

When the gaze direction of the user is detected based on the image captured by the first camera 460, the controller 440 matches images captured by the plurality of second cameras 410 with one another. The controller 440 detects a region corresponding to the gaze direction of the user from the matched images and displays the region on the display unit 420.

Differently from FIG. 2, the shooting direction of the second camera 410 is not controlled by the actuator 430 according to the embodiment illustrated in FIG. 6. Instead, the image of the gaze direction is detected among the matched images acquired using the plurality of second cameras 410.

The number of the second camera 410 mounted on the display apparatus 400 may be determined in consideration of a viewing angle of the second camera 410 such that the matched images cover changes of the gaze direction of the user.

Referring to FIG. 7, one second camera 410 using a wide angle lens is mounted on the display apparatus 400.

As illustrated in FIG. 7, due to the wide angle lens, the second camera 410 may capture an image in a wide area.

When the gaze direction of the user is detected from the image captured by the first camera 460, the controller 440 detects a region corresponding to the gaze direction of the user from the image captured by the second camera 410 including the wide angle lens and displays the region on the display unit 420.

In this case, the actuator 430 may also be used in the same manner as illustrated in FIG. 2. Since distortion may occur at edges of an image captured using a wide angle lens, the shooting direction of the second camera 410 may be controlled to be identical to the gaze direction by a desired degree (that may or may not be predetermined) using the actuator 430, the region corresponding to the gaze direction of the user may be detected from the image captured by the second camera 410, and the region may be displayed on the display unit 420.

Although not illustrated in the drawings, the viewing angle of the second camera 410 may be widened using a plurality of image sensors as if a wide angle lens is used. Images acquired by the plurality of image sensors of the second camera 410 are matched, and a region corresponding to the gaze direction is detected among the matched images to be displayed on the display unit 420.

As described above, the controller 440 displays a real image captured by the second camera 410 and an augmented reality image generated by overlaying a virtual image upon the real image on the display unit 420.

The display apparatus 400 may include an image storage unit 470 in which a three-dimensional (3D_pre-operative medical image of an object, for example, a patient and a virtual image generated by projecting the 3D pre-operative medical image onto an image acquired by the endoscope 220 are stored. In this regard, “pre-operative medical image” may be a computed tomography (CT) image, a magnetic resonance imaging (MRI) image, a positron emission tomography (PET) image, a single photon emission computed tomography (SPECT) image, an ultrasonography (US) image, or the like, without being limited thereto.

To this end, the controller 440 of the display apparatus 400 may generate a virtual image by converting the pre-operative medical image of the patient into a 3D image and projecting the 3D image onto the real image acquired by the endoscope 220 and received from a slave system 200 of a surgical robot system which will be described later.

In particularly, the communication unit 450 of the display apparatus 400 receives a medical image from a medical image database DB constructed with pre-operative medical images of patients, such as CT scans or MRI images. When the communication unit 450 receives the medical image, the controller 440 may convert the received medical image into a 3D image and store the converted 3D image in the image storage unit 470. In addition, the communication unit 450 may receive the real image of the surgical region inside the patient acquired by the endoscope 220 from the slave system 200, and the controller 440 may generate a virtual image by projecting the 3D image onto the real image received by the communication unit 450 and store the generated virtual image in the image storage unit 470.

The communication unit 450 of the display apparatus 400 may transmit and receive information in a wireless communication manner.

As described above, the controller 440 of the display apparatus 400 may generate an augmented reality image by overlaying the virtual image upon the real image. Alternatively, an imaging system of a surgical robot system, which will be described later, may generate a virtual image, and the communication unit 450 of the display apparatus 400 may receive the virtual image. Thus, an augmented reality image may be displayed by synthesizing the virtual image received by the communication unit 450 and the real image captured by the second camera 410 while the controller 440 does not directly generate the virtual image.

As the gaze direction of the user changes, the real image captured by the second camera 410 and displayed on the display unit 420 is also changed in accordance with the gaze direction as described above. As the real image is changed according to the gaze direction, the virtual image overlaid upon the real image is also changed into a virtual image corresponding to the real image of the gaze direction.

Thus, the user of the display apparatus 400 may place the display apparatus 400 at the surgical region of the patient at a desired distance (that may or may not be predetermined) and check images of surgery performed inside the patient's body via the augmented reality image displayed on the display unit 420. As described above, the augmented reality image is naturally changed and displayed according to the gaze direction of the user. Thus, the user may observe the inside of the patient's body using the display apparatus 400 as through the user were directly viewing the inside of the patient.

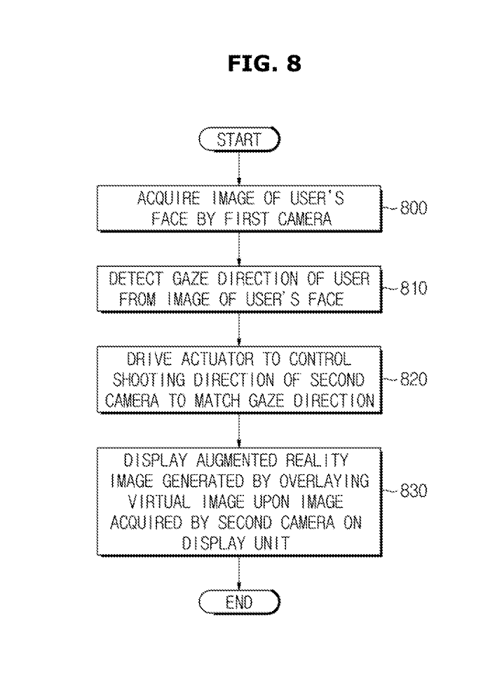

FIGS. 8-11 are flowcharts illustrating methods of controlling a display apparatus 400.

Referring to FIGS. 8-11, a first camera 460 acquires an image of a face of a user (800, 900, 940, 950).

As illustrated in FIGS. 2 and 3, the first camera 460 is mounted at an upper end of the front surface of the display apparatus 400. The first camera 460 may also be mounted at another position of the front surface of the display apparatus 400. However, the first camera 460 may be mounted at the upper end thereof to capture an image of a face, particularly, eyes, of the user of the display apparatus 400. The first camera 460 continuously captures images of the face of the user during operation of the display apparatus 400 and outputs data acquired during image capture to the controller 440 in real time.

The controller 440 detects the gaze direction of the user from the image of the user's face acquired by the first camera 460 (810, 910, 941, 951).

When the first camera 460 captures an image of the user's face and outputs the image to the controller 440, the controller 440 detects the gaze direction of the user using movement of pupils in the image of the user's face or by based on a rotation direction of the user's face. Alternatively, the gaze direction of the user may be detected by combining the rotation direction of the user's face and the movement of pupils of the user.

The display apparatus 400 may pre-store algorithms to detect the gaze direction of the user, and the controller 440 may detect the gaze direction of the user using the algorithms.

When the gaze direction of the user is detected, the controller 440 drives the actuator 430 such that the shooting direction of the second camera 410 matches the detected gaze direction (820).

When the gaze direction of the user is detected based on the image captured by the first camera 460, the controller 440 controls the shooting direction of the second camera 410 such that the shooting direction of the second camera 410 matches the detected gaze direction of the user.

As illustrated in FIG. 5, under the condition that the shooting direction of the second camera 410 faces a lower position than the detected gaze direction of the user, the controller 440 outputs a drive signal to drive the actuator 430 so as to adjust the shooting direction of the second camera 410 to match the user's gaze direction.

The actuator 430 tilts the second camera 410 according to the drive signal output from the controller 440 such that the shooting direction of the second camera 410 matches the gaze direction of the user.

The controller 440 detects the gaze direction of the user from the image captured by the first camera 460 in real time. When a change in the gaze direction of the user is detected, the controller 440 drives the actuator 430 in real time such that the shooting direction of the second camera 410 matches the changed gaze direction.

The controller 440 displays an augmented reality image generated by overlaying a virtual image upon the image acquired by the second camera 410 on the display unit 420 (830, 930, 943, 953).

When the communication unit 450 receives a medial image from a medical image database DB constructed with pre-operative medical images of patients, such as CT scans or MRI images, the controller 440 converts the received medical image into a 3D image. When the communication unit 450 receives a real image of the surgical region inside the patient's body acquired by the endoscope 220 and received from the slave system 200, the controller 440 generates a virtual image by projecting the 3D image onto the real image received by the communication unit 450, generates an augmented reality image by overlaying the generated virtual image upon the image acquired by the second camera 410, and displays the augmented reality image on the display unit 420.

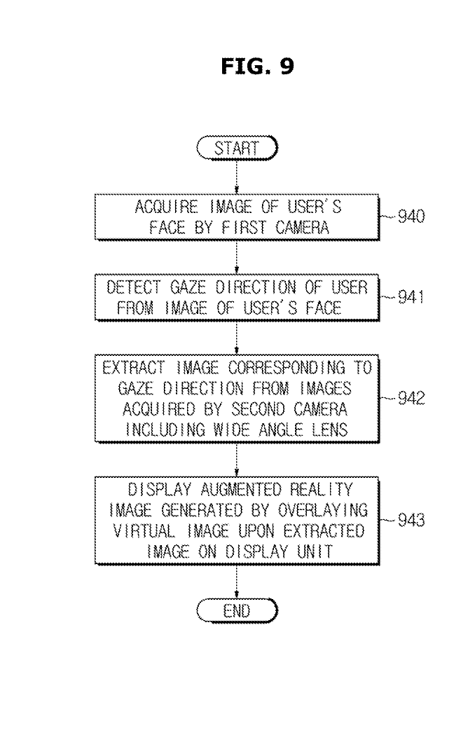

Methods illustrated in FIGS. 9-11 are similar to the method of FIG. 8 except for (820), and thus a description will be given of these difference alone.

Referring to FIG. 9, when the gaze direction is detected, the controller 440 matches images acquired by a plurality of cameras with one another and extract an image corresponding to the gaze direction from the matched images (920).

Differently from the embodiment illustrated in FIG. 8, the shooting direction of the second camera 410 is not controlled using the actuator 430. Instead, an image corresponding to the gaze direction is detected from the matched images acquired by the plurality of second cameras 410. The number of the second camera 410 mounted on the display apparatus 400 may be determined in consideration of a viewing angle of the second camera 410 such that the matched images cover changes of the gaze direction of the user.

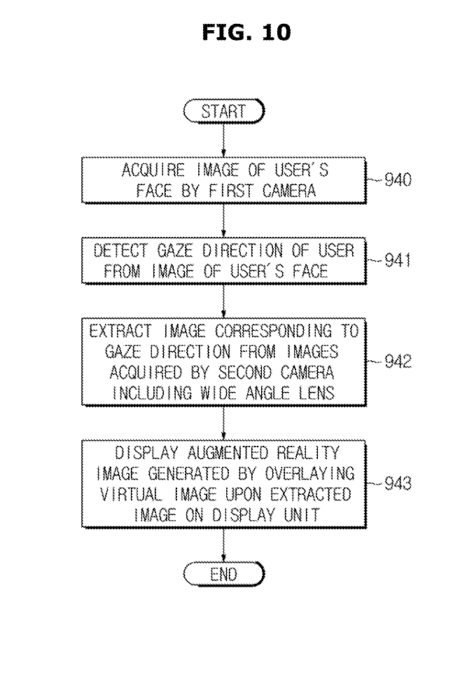

Referring to FIG. 10, when the gaze direction is detected, an image corresponding to the gaze direction is extracted from images acquired by a second camera 410 including a wide angle lens (942).

As illustrated in FIG. 7, since the second camera 410 includes a wide angle lens with a wide viewing angle, a wide area may be captured. When the gaze direction of the user is detected from an image captured by the first camera 460, the controller 440 extracts an image corresponding to the gaze direction of the user from images captured by the second camera 410 using a wide angle lens.

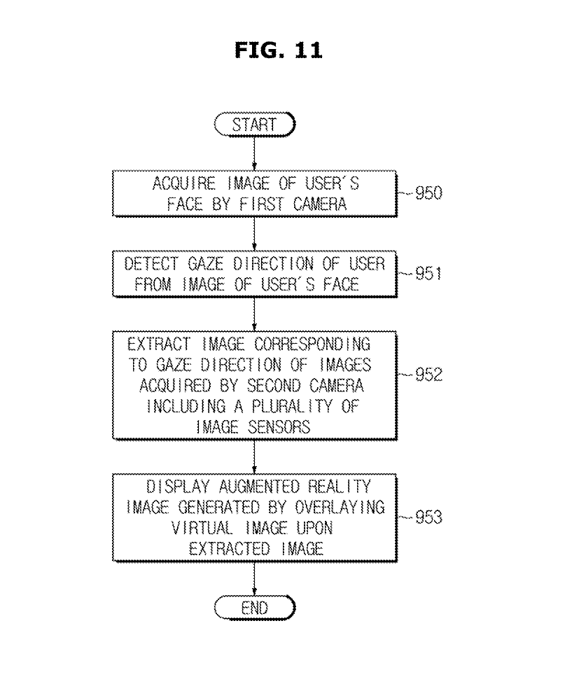

Referring to FIG. 11, when the gaze direction is detected, an image corresponding to the gaze direction is extracted from the images acquired by the second camera 410 including a plurality of image sensors (952).

The viewing angle of the second camera 410 may be widened using the plurality of image sensors as if a wide angle lens is used. Images acquired by the plurality of image sensors of the second camera 410 are matched with one another, and then an image corresponding to the gaze direction is extracted from the matched images.

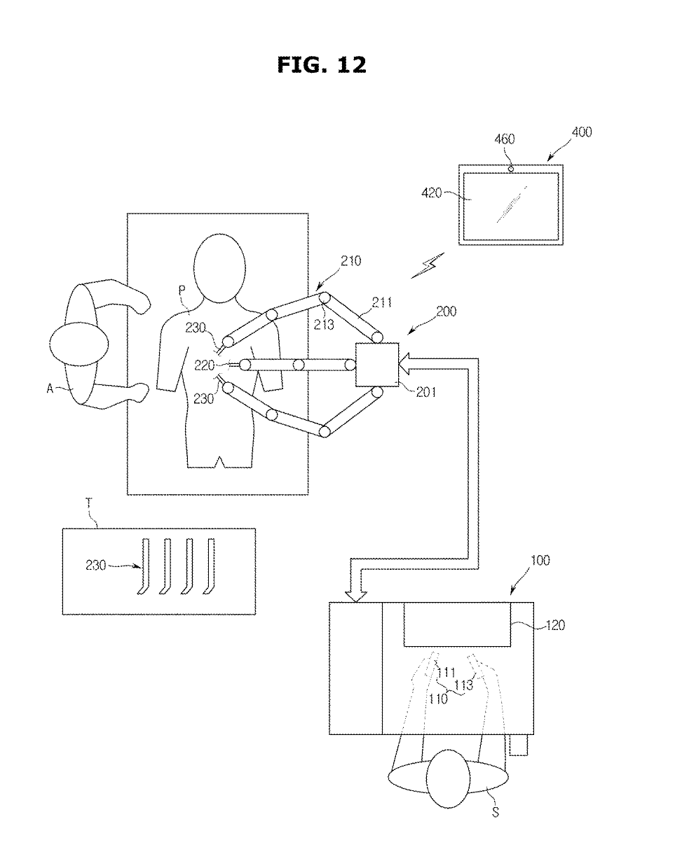

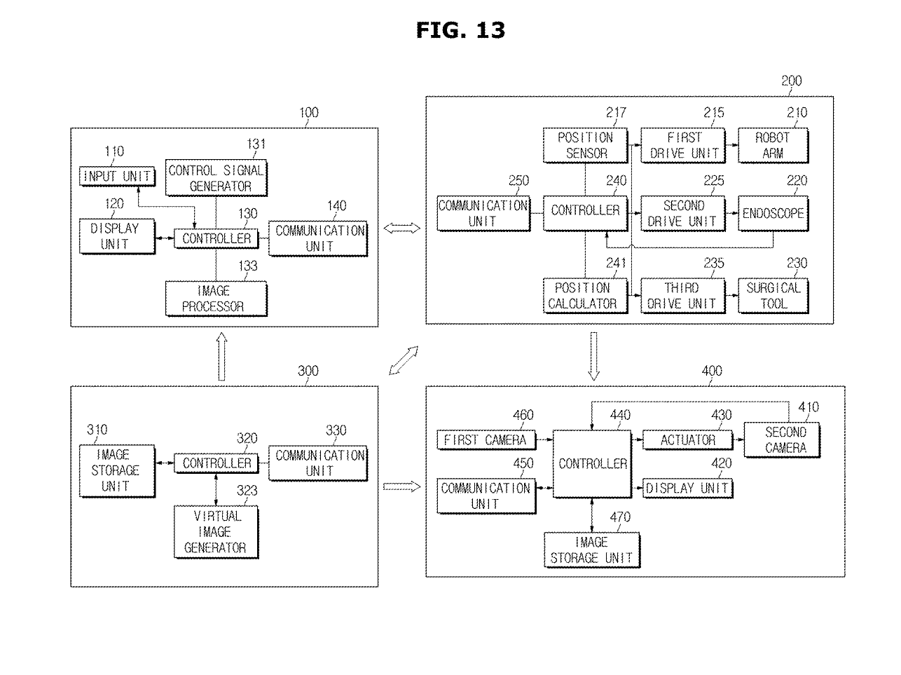

FIG. 12 is a diagram illustrating a surgical robot system. FIG. 13 is a block diagram schematically illustrating constituent elements of a surgical robot system.

The surgical robot system may include a slave system 200 that performs surgery upon a patient P who lies on an operating table, and a master system 100 that remotely controls the slave system 200 in accordance with manipulation of an operator S (e.g., a doctor). In this regard, at least one assistant A assisting the operator S may be positioned near the patient P.

In this regard, assisting the operator S may refer to assisting a surgical operation while surgery is in progress, such as replacing surgical tools, but is not limited thereto. For example, a variety of surgical instruments may be used according to the surgical operation. Since the number of robot arms 210 of the slave system 200 is limited, the number of surgical tools mounted thereon at once is also limited. Accordingly, when the surgical tool needs to be replaced during surgery, the operator S instructs the assistant A positioned near the patient P to replace the surgical tool. In accordance with the instruction, the assistant A removes a surgical tool not in use from the robot arm 210 of the slave system 200 and mounts another surgical tool placed on a tray T on the corresponding robot arm 210.

The assistant A may also drive the aforementioned display apparatus 400 to observe the surgical region through an augmented reality image displayed on the display apparatus 400 and transmit information regarding the surgery in real time to the operator S.

The master system 100 and the slave system 200 may be separately arranged as physically independent devices, without being limited thereto. For example, the master system 100 and the slave system 200 may be integrated with each other as a single device.

As illustrated in FIGS. 12 and 13, the master system 100 may include an input unit 110 and a display unit 120.

The input unit 110 refers to an element that receives an instruction for selection of an operation mode of the surgical robot system or an instruction for remote control of the operation of the slave system 200 input by the operator S. In the present embodiment, the input unit 110 may include a haptic device, a clutch pedal, a switch, and a button, but is not limited thereto. For example, a voice recognition device may be used. Hereinafter, a haptic device will be exemplarily described as an example of the input unit 110.

FIG. 12 exemplarily illustrates that the input unit 110 includes two handles 111 and 113, but the present embodiment is not limited thereto. For example, the input unit 110 may also include one handle or three or more handles as well.

The operator S may respectively manipulate two handles 111 and 113 using both hands as illustrated in FIG. 12 to control operation of the robot arm 210 of the slave system 200. Although not shown in detail in FIG. 12, each of the handles 111 and 113 may include an end effector, a plurality of links, and a plurality of joints.

In this regard, the end effector may have a pencil or stick shape with which a hand of the operator S is in direct contact, without being limited thereto.

A joint refers to a connection between two links and may have 1 degree of freedom (DOF) or greater. Here, “degree(s) of freedom (DOF)” refers to a DOF with regard to kinematics or inverse kinematics. A DOF of a device indicates the number of independent motions of a device or the number of variables that determine independent motions at relative positions between links. For example, an object in a 3D space defined by X-, Y-, and Z- axes has at least one DOF selected from the group consisting of 3 DOF to determine a spatial position of the object (a position on each axis), 3 DOF to determine a spatial orientation of the object (a position on each axis), and 3 DOF to determine a spatial orientation of the object (a rotation angle relative to each axis). More specifically, it will be appreciated that when an object is movable along each of X-, Y-, and Z- axes and is rotatable about each of X-, Y-, and Z- axes, it will be appreciated that the object has 6 DOF.

In addition, a detector (not shown) may be mounted on the joint. The detector may detect information indicating the state of the joint, such as force/torque information applied to the joint, position information of the joint, and speed information when in motion. Accordingly, in accordance with manipulation of the input unit 110 by the operator S, the detector (not shown) may detect information regarding the status of the manipulated input unit 110, and a controller 130 may generate a control signal corresponding to information regarding the status of the input unit 110 detected by the detector (not shown) by use of a control signal generator 131 to transmit the generated control signal to the slave system 200 via a communication unit 140. That is, the controller 130 of the master system 100 may generate a control signal according to manipulation of the input unit 110 by the operator S using the control signal generator 131 and transmit the generated control signal to the slave system 200 via the communication unit 140.

The display unit 120 of the master system 100 may display a real image of the inside of the patient P's body acquired by the endoscope 220 and a 3D image generated using a pre-operative medical image of the patient P. To this end, the master system 100 may include an image processor 133 that receives image data from the slave system 200 and an imaging system 300 and outputs the image information to the display unit 120. In this regard, “image data” may include a real image of the inside of the patient P's body acquired by the endoscope 220 and a 3D image generated using a pre-operative medical image of the patient P as described above, but is not limited thereto.

The display unit 120 may include at least one monitor, and each monitor may be implemented to individually display information required for surgery. For example, when the display unit 120 includes three monitors, one of the monitors may display the real image of the inside of the patient P's body acquired by the endoscope 220 or the 3D image generated using a pre-operative medical image of the patient P, and the other two monitors may respectively display information regarding the status of motion of the slave system 200 and information regarding the patient P. In this regard, the number of monitors may vary according to the type and kind of information to be displayed.

Here, “information regarding the patient” may refer to information indicating vital signs of the patient, for example, bio-information such as body temperature, pulse, respiration, and blood pressure. In order to provide such bio-information to the master system 100, the slave system 200, which will be described later, may further include a bio-information measurement unit including a body temperature-measuring module, a pulse-measuring module, a respiration-measuring module, a blood pressure-measuring module, and the like. To this end, the master system 100 may further include a signal processor (not shown) to receive bio-information from the slave system 200, process the bio-information, and output the processed information on the display unit 120.

The slave system 200 may include a plurality of robot arms 210 and various surgical tools 230 may be mounted on ends of the robot arms 210. The robot arms 210 may be coupled to a body 201 in a fixed state and supported thereby as illustrated in FIG. 12. In this regard, the numbers of the surgical tools 230 and the robot arms 210 used at once may vary according to various factors, such as diagnostic methods, surgical methods, and spatial limitations of the operating room.

In addition, each of the robot arms 210 may include a plurality of links 211 and a plurality of joints 213. Each of the joints 213 may connect links 211 and may have 1 DOF or greater.

In addition, a first drive unit 215 to control motion of the robot arm 210 according to the control signal received from the master system 100 may be mounted on each of the joints of the robot arm 210. For example, when the operator S manipulates the input unit 110 of the master system 100, the master system 100 generates a control signal corresponding to the status information of the manipulated input unit 110 and transmits the control signal to the slave system 200, and a controller 240 of the slave system 200 drives the first drive unit 215 in accordance with the control signal received from the master system 100, so as to control motion of each joint of the robot arm 210. Meanwhile, each joint of the robot arm 210 of the slave system 200 may move according to the control signal received from the master system 100 as described above. However, the joint may also move by external force. That is, the assistant A positioned near the operating table may manually move each of the joints of the robot arm 210 to control the location of the robot arm 210, or the like.

Although not illustrated in FIG. 12, the surgical tool 230 may include a housing mounted on an end of the robot arm 210 and a shaft extending from the housing by a desired length (that may or may not be predetermined).

A drive wheel may be coupled to the housing. The drive wheel may be connected to the surgical tool 230 via a wire, or the like, and the surgical tool 230 may be driven via rotation of the drive wheel. To this end, a third drive unit 235 may be mounted on one end of the robot arm 210 for rotation of the drive wheel. For example, in accordance with manipulation of the input unit 110 of the master system 100 by the operator S, the master system 100 generates a control signal corresponding to information regarding the status of the manipulated input unit 110 and transmits the generated control signal to the slave system 200, and the controller 240 of the slave system 200 drives the third drive unit 235 according to the control signal received from the master system 100, so as to drive the surgical tool 230 in a desired manner. However, the operating mechanism of the surgical tools 230 is not necessarily constructed as described above, and various other electrical/mechanical mechanisms to realize required motions of the surgical tool 230 may also be employed.

Examples of the surgical tool 230 may include a skin holder, a suction line, a scalpel, scissors, a grasper, a surgical needle, a needle holder, a stapler, a cutting blade, and the like, without being limited thereto. Any known tools required for surgery may also be used.

In general, the surgical tools 230 may be classified into main surgical tools and auxiliary surgical tools. Here, “main surgical tools” may refer to surgical tools performing direct surgical motion, such as cutting, suturing, cauterization, and rinsing, on the surgical region, for example, a scalpel or surgical needle. “Auxiliary surgical tools” may refer to surgical tools that do not perform direct motion in the surgical region and assist motion of the main surgical tools, for example, a skin holder.

Likewise, the endoscope 220 does not perform direct motions on a surgical region and is used to assist a motion of the main surgical tool. Thus, the endoscope 220 may be considered an auxiliary surgical tool in a broad sense. The endoscope 220 may include various surgical endoscopes, such as a thoracoscope, an arthroscope, a rhinoscope, a cysotoscope, a rectoscope, a duodenoscope, and a cardioscope, in addition to a laparoscope that is mainly used in robotic surgery.

In addition, the endoscope 220 may be a complementary metal-oxide semiconductor (CMOS) camera and a charge coupled device (CCD), but is not limited thereto. In addition, the endoscope 220 may include a lighting unit to radiate light to the surgical region. The endo scope 220 may also be mounted on one end of the robot arm 210 as illustrated in FIG. 12, and the slave system 200 may further include a second drive unit 225 to drive the endoscope 220. The controller 240 of the slave system 200 may transmit images acquired by the endoscope 220 to the master system 100 and the imaging system 300 via a communication unit 250.

In addition, the slave system 200 according to the illustrated embodiment may include a position sensor 217 to detect a current position of the surgical tool 230 as illustrated in FIG. 13. In this regard, the position sensor 217 may be a potentiometer, an encoder, or the like, but is not limited thereto.

The position sensor 217 may be mounted on each joint of the robot arm 210 provided with the surgical tool 230. The position sensor 217 detects information regarding the status of motion of each joint of the robot arm 210. The controller 240 receives the detected information from the position sensor 217 and calculates the current position of the surgical tool 230 using a position calculator 241. The position calculator may calculate the current position of the surgical tool 230 by applying the input information to kinematics of the robot arm 210. In this regard, the calculated current position may be coordinate values. In addition, the controller 240 may transmit the calculated coordinate values of the position of the surgical tool 230 to a display apparatus 400, which will be described later.

As described above, since the current position of the surgical tool 230 is estimated by detecting the status of each joint of the robot arm 210 provided with the surgical tool 230, the position of the surgical tool 230 may be efficiently estimated even when the surgical tool 230 is located outside the field of view (FOV) of the endoscope 220, or when the FOV of the endoscope 220 is blocked by internal organs, or the like.

In addition, although not illustrated in FIG. 12, the slave system 200 may further include a display unit (not shown) that may display an image of a surgical region of the patient P acquired by the endoscope 220.

The imaging system 300 may include an image storage unit 310 to store a 3D image generated using a pre-operative medical image of the patient P, a virtual image obtained by projecting the 3D image onto an image acquired by the endoscope 220, and the like. In this regard, “pre-operative medical image” may be a computed tomography (CT) image, a magnetic resonance imaging (MRI) image, a positron emission tomography (PET) image, a single photon emission computed tomography (SPECT) image, an ultrasonography (US) image, or the like, without being limited thereto.

To this end, the imaging system 300 may include a virtual image generator 323 that converts the pre-operative medical image of the patient into a 3D image and generates a virtual image by projecting the 3D image onto a real image acquired by the endoscope 220 and received from the slave system 200.

Particularly, a controller 320 of the imaging system 300 may receive a medical image from a medical image database DB constructed with pre-operative medical images of patients, such as CT images or MRI images, convert the received medical image into a 3D image via the virtual image generator 323, and store the obtained 3D image in the image storage unit 310. In addition, the controller 320 may receive a real image of the surgical region of the patient P acquired by the endoscope 220 and received from the slave system 200, generate a virtual image obtained by projecting the 3D image onto the received real image by the virtual image generator 323, and store the generated virtual image in the image storage unit 310. As described above, the 3D image and the virtual image stored in the image storage unit 310 may be transmitted to the master system 100, the slave system 200, and the display apparatus 400, which will be described later, through a communication unit 330.

The imaging system 300 may be integrated with the master system 100 or the slave system 200, without being limited thereto, and may also be separated therefrom as an independent device.

The display apparatus 400 is the same as that described above with reference to FIGS. 1-11, and thus a detailed description thereof will not be given.

The controller 440 of the display apparatus 400 displays an augmented reality image generated by overlaying the virtual image upon the real image captured by the second camera 410 on the display unit 420.

The display apparatus 400 may include the image storage unit 470 in which the 3D image of the pre-operative medical image of the object, for example, the patient, and a virtual image generated by projecting the 3D image onto the image acquired by the endoscope 220 are stored. To this end, the controller 440 of the display apparatus 400 may generate a virtual image by converting a pre-operative medical image of the patient into a 3D image and projecting the 3D image onto a real image acquired by the endoscope 220 and received from the slave system 200.

Particularly, the communication unit 450 of the display apparatus 400 may receive a medical image from a medical image database DB constructed with pre-operative medical images of patients, such as CT images or MRI images. When the communication unit 450 receives the medical image, the controller 440 may convert the received medical image into a 3D image and store the converted 3D image in the image storage unit 470. In addition, the communication unit 450 may receive the real image of the surgical region inside the patient acquired by the endoscope 220 from the slave system 200, and the controller 440 may generate a virtual image by projecting the 3D image onto the real image received by the communication unit 450 and store the generated virtual image on the image storage unit 470.

As described above, the controller 440 of the display apparatus 400 may generate an augmented reality image by overlaying the virtual image upon the real image. Alternatively, the aforementioned imaging system of a surgical robot system, which will be described later, may generate a virtual image, and the communication unit 450 of the display apparatus 400 may receive the virtual image. Thus, an augmented reality image may be displayed by synthesizing the virtual image received by the communication unit 450 and the real image captured by the second camera 410 while the controller 440 does not directly generate the virtual image.

As the gaze direction of the user changes, the real image captured by the second camera 410 and displayed on the display unit 420 is also changed in accordance with the gaze direction as described above. As the real image is changed according to the gaze direction, the virtual image overlaid upon the real image is also changed to a virtual image corresponding to the real image of the gaze direction.

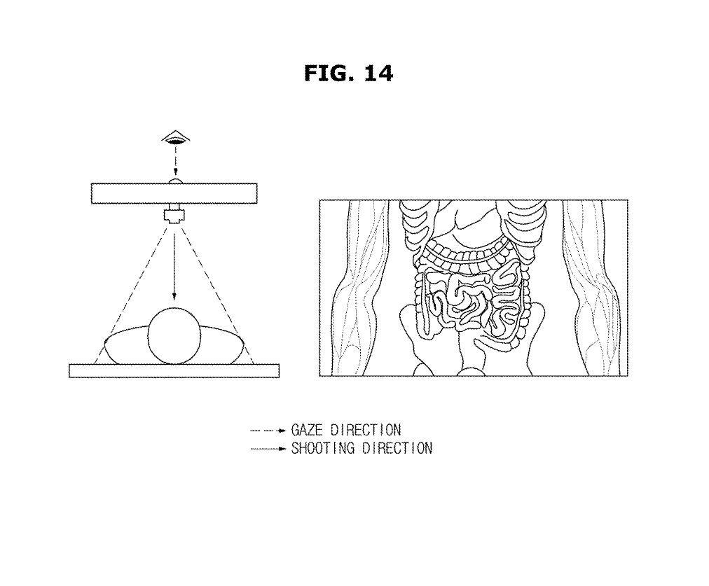

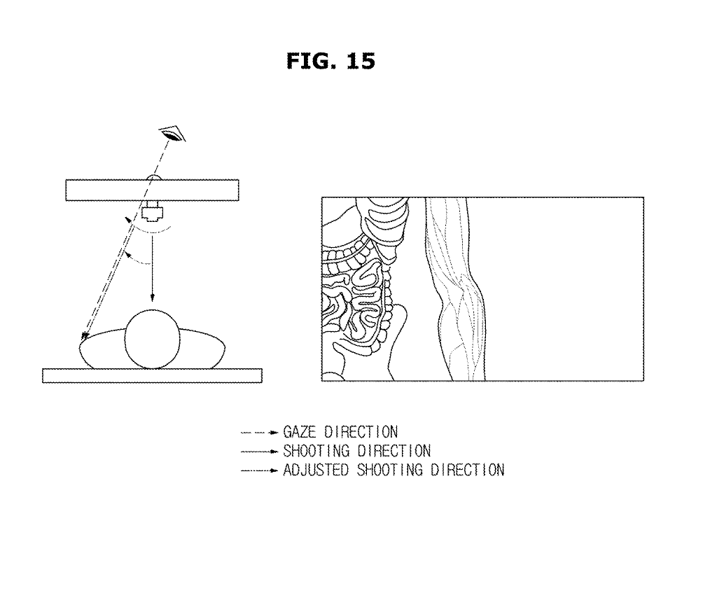

For example, referring to FIGS. 14 and 15, when the display apparatus 400 faces the abdomen of the patient P at the center of the patient P, the controller 440 detects the gaze direction of the user based on an image of the user's face captured by the first camera 460. When the detected gaze direction faces the center of the abdomen of the patient P, the communication unit 450 receives a virtual image of a corresponding region from the imaging system 300, and the controller 440 overlays the received virtual image from the communication unit 450 upon a real image captured by the second camera 410, so that an augmented reality image in which the abdomen of the patient P is disposed at the center thereof.

In addition, as illustrated in FIG. 15, when the detected gaze direction diagonally faces the left side of the abdomen of the patient P at a position deviated from the center of the abdomen, the controller 440 drives the actuator 430 such that the shooting direction of the second camera 410 matches the gaze direction. The communication unit 450 receives a virtual image of a corresponding region from the imaging system 300, and the controller 440 overlays the virtual image received by the communication unit 450 upon the real image acquired by the second camera 410 having an adjusted shooting direction. As a result, an augmented reality image in which about a half of the abdomen of the patient P is disposed at a left side of the display unit 420 is generated.

As described above, the display apparatus 400 according to the illustrated embodiment may observe the inside of the patient's body changed according to movement of the gaze direction of the user in real time. That is, since an augmented reality image in which a portion viewed by the user faces the front may be generated in real time directly corresponding to the change of the gaze direction of the user and may be displayed, the inside of the patient P's body may be more instinctively observed compared to a conventional device by which the inside of the patient P's body by designating a gaze direction and a position thereof using an input device such as a mouse, a keyboard, and a joystick.

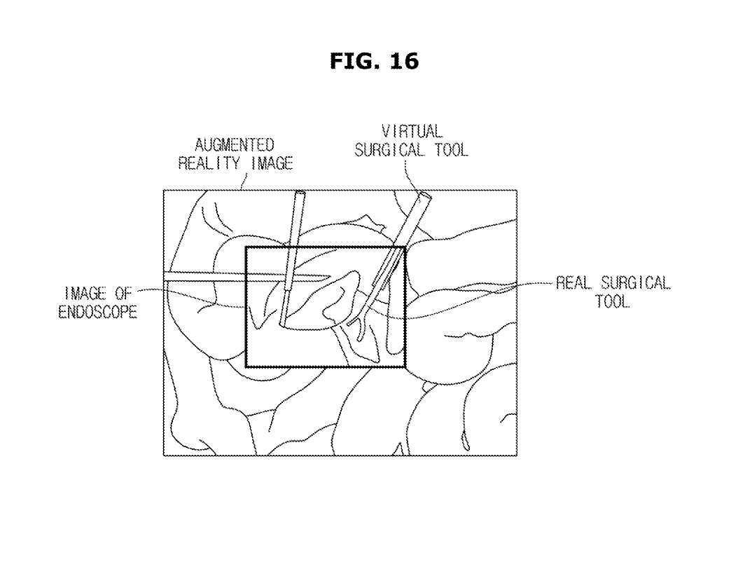

In addition, the controller 440 of the display apparatus 400 may receive current position information of the surgical tool from the slave system 200 to generate a virtual surgical tool at a matching region of the augmented reality image. Here, “position information” may be coordinate values as described above. The controller 440 may generate the virtual surgical tool at coordinates matching the received coordinate values of the surgical tool on the augmented reality image. In this regard, as illustrated in FIG. 16, when the image of the surgical tool is captured by the endoscope 220, the real image of the surgical tool may be displayed at a portion overlapping the virtual surgical tool using the real image of the surgical tool.

That is, according to the present embodiment as illustrated in FIG. 16, the augmented reality image may be an image generated by compositing a 3D image generated using the pre-operative medical image of the patient, the virtual surgical tool generated using the image acquired by the endoscope 220, and position information of the surgical tool received from the slave system 200. In this regard, when the image acquired by the endoscope 220 does not contain the surgical tool, the augmented reality image may include only the virtual surgical tool. When the real image acquired by the endoscope 220 contains the surgical tool, the virtual surgical tool and the real image of the surgical tool may be composited as illustrated in FIG. 16.

According to the present embodiment, the assistant A who may directly observe the patient P may use the display apparatus 400. That is, the display apparatus 400 that is a system to instinctively observe the inside of the patient P's body may be used by a user who may directly observe the patient P.

For example, the assistant A may observe the inside of the patient P's body using a separate monitor in an operating room. In this regard, since the monitor is generally located at a region not adjacent to the patient P, it is impossible for the assistant A to simultaneously observe the patient and watch the monitor. During surgery, in accordance with an instruction to retool the robot arm 210 from the operator S, the assistant A needs to retract the robot arm 210, replace the surgical tool currently used in a state of being inserted into the patient P with another surgical tool, and insert the replaced into the patient P. In this case, the surgical tool is located near the patient P and the inside of the patient P's body needs to be checked through the separate monitor. Thus, the assistant A needs to retract the robot arm 210 from the patient P and retool the robot arm 210 while observing the inside of the patient P's body through the monitor. Accordingly, retooling of the surgical tool may be delayed, and peripheral organs and tissues may be damaged during retooling of the surgical tool while observation is not instinctively performed.

However, when the assistant A assists the surgical operation while wearing the display apparatus 400 according to the present embodiment, the inside of the patient P's body may be instinctively observed through the display unit 420 that displays the status of the inside of the patient P's body while observing the patient P without watching a separate monitor. Thus, assistant tasks such as retooling of the robot arm 210 may be quickly performed. In addition, the assistant A may provide detailed information by observing regions that are missed by the operator S positioned far away from the operating room, thereby improving surgery quality.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A display apparatus, comprising:
a display unit configured to display images;
a first camera, mounted on a surface of the display unit on which the images are displayed, configured to acquire an image of a user's face;
a second camera, mounted on a surface of the display unit opposite to the first camera, configured to acquire an image of an object; and
a controller configured to detect a gaze direction of the user from the image of the user's face acquired by the first camera, configured to control a shooting direction of the second camera to match the detected gaze direction, and configured to display the image of the object acquired by the second camera, having an adjusted shooting direction, on the display unit.

2. The display apparatus according to claim 1, further comprising:
an actuator configured to control the shooting direction of the second camera;
wherein the controller is configured to drive the actuator to allow the shooting direction of the second camera to match the detected gaze direction.

3. The display apparatus according to claim 2, wherein the actuator is installed between the second camera and the display unit, and
wherein the actuator is configured to tilt the second camera to control the shooting direction of the second camera.

4. The display apparatus according to claim 1, wherein the second camera comprises a wide angle lens, and
wherein the controller is configured to extract an image corresponding to the detected gaze direction from images acquired by the second camera comprising the wide angle lens and is configured to display the extracted image on the display unit.

5. The display apparatus according to claim 1, wherein the display apparatus further comprises a plurality of second cameras mounted on the surface of the display unit opposite to the first camera, and
wherein the controller is configured to match images captured by the plurality of second cameras, is configured to extract an image corresponding to the detected gaze direction from the matched images, and is configured to display the extracted image on the display unit.

6. The display apparatus according to claim 1, wherein the second camera comprises a plurality of image sensors, and
wherein the controller is configured to extract an image corresponding to the detected gaze direction from images sensed by the plurality of image sensors, and is configured to display the extracted image on the display unit.

7. The display apparatus according to claim 1, wherein the display unit is a liquid crystal display (LCD) or a semi-transparent LCD.

8. The display apparatus according to claim 1, wherein the controller is configured to detect the gaze direction of the user from the image of the user's face captured by the first camera and is configured to control the shooting direction of the second camera in real time to match the gaze direction detected in real time.

9. The display apparatus according to claim 1, wherein the controller is configured to display an augmented reality image generated using a virtual image of an inside of the object and overlaying the virtual image upon the image captured by the second camera on the display unit.

10. The display apparatus according to claim 1, wherein the controller is configured to generate a virtual image by converting an image of an inside of the object into a three-dimensional image.

11. The display apparatus according to claim 10, wherein the image of the inside of the object comprises at least one image selected from a group consisting of an image captured by a medical imaging apparatus, an image of a surgical region, and a surgical tool captured by an endoscope.

12. The display apparatus according to claim 11, wherein the medical imaging apparatus comprises a computed tomography (CT) apparatus or a magnetic resonance imaging (MRI) apparatus.

13. A surgical robot system, comprising:
a slave system configured to perform a surgical operation upon an object;
a master system configured to control the surgical operation of the slave system;
an imaging system configured to generate a virtual image of an inside of the object; and
a display apparatus comprising:
a display unit configured to display images;
a first camera, mounted on a surface of the display unit on which the images are displayed, configured to acquire an image of a user's face;
a second camera, mounted on a surface of the display unit opposite to the first camera, configured to acquire an image of an object; and
a controller configured to detect a gaze direction of the user from the image of the user's face acquired by the first camera, configured to control a shooting direction of the second camera to match the detected gaze direction, and configured to display an augmented reality image, generated by overlaying the virtual image upon the image of the object acquired by the second camera, having an adjusted shooting direction, on the display unit.

14. The surgical robot system according to claim 13, wherein the imaging system comprises:
a virtual image generator configured to generate the virtual image by converting the image of the inside of the object into a three-dimensional image; and
a storage unit configured to store the virtual image.

15. The surgical robot system according to claim 14, wherein the image of the inside of the object comprises an image acquired by a medical imaging apparatus, comprising a computed tomography (CT) apparatus or a magnetic resonance imaging (MRI) apparatus, and an image of a surgical region and a surgical tool captured by an endoscope, and
wherein the virtual image generator is configured to generate the virtual image by converting the image acquired by the medical imaging apparatus comprising a CT apparatus or a MRI apparatus into a three-dimensional image and projecting the converted three-dimensional image onto the image of the surgical region and the surgical tool captured by the endoscope.

16. A method of controlling a mobile display apparatus, the method comprising:
detecting a gaze direction of a user from an image of the user's face acquired by a first camera of the mobile display apparatus;
controlling a shooting direction of a second camera of the mobile display apparatus to match the gaze direction; and
displaying an image acquired by the second camera, having an adjusted shooting direction, on a display unit of the mobile display apparatus.

17. The method according to claim 16, further comprising:
generating a virtual image of an inside of an object; and
displaying an augmented reality image generated by overlaying the virtual image of the object upon an image acquired by the second camera on the display unit.

18. A display apparatus, comprising:
a display unit configured to display images;
a first camera, on a first side of the display unit, configured to acquire an image of a face of a user;
a second camera, on a second side of the display unit, configured to acquire an image of an object; and
a controller configured to detect a gaze direction of the user from the acquired image of the face of the user, and configured to control a shooting direction of the second camera so that the shooting direction matches the detected gaze direction.

19. The display apparatus according to claim 18, further comprising:
an actuator configured to adjust the shooting direction of the second camera;
wherein the controller drives the actuator.

20. The display apparatus according to claim 18, further comprising:
an actuator configured to adjust the shooting direction of the second camera;
wherein the actuator is operatively connected between the display unit and the second camera, and
wherein the controller drives the actuator.
